(19) United States
(12) Patent Application Publication
(10) Pub. No.: US 2006/0117016 A1
(43) Pub. Date: Jun. 1, 2006

(54) Method and apparatus for efficient electronic document management

(75) Inventors: Lanette E. Smith, Farmington, AR (US); Mary J. Guimond, Darien, CT (US); Thomas Y. Kwok, Washington Township, NJ (US); Charles W. Myers, Flower Mound, TX (US); Thao N. Nguyen, Katonah, NY (US)

Correspondence Address: Moser, Patterson & Sheridan, LLP, Suite 100, 595 Shrewsbury Avenue, Shrewsbury, NJ, 07702, US

(73) Assignee: International Business Machines Corporation, Armonk, NY (US)

(21) Appl. No.: 11/329,305

(22) Filed: Jan. 10, 2006

Related U.S. Application Data
(63) Continuation-in-part of application No. 10/970,163, filed on Oct. 21, 2004.

(51) Int. Cl. G06F 17/30

(52) U.S. Cl. 707/9

(57) ABSTRACT

In one embodiment, the present invention is a method and apparatus for efficient electronic document management. One embodiment of the inventive method involves retrieving a user-specific administrator setup file comprising a plurality of parameters pertaining to tasks that a user is authorized to perform on electronic documents, selecting at least one authorized task for performance on a selected electronic document, in accordance with the user-specific administrator setup files, and executing the selected authorized tasks in accordance with at least one set of predefined task execution instructions.

### CROSS REFERENCE TO RELATED APPLICATIONS

This application is a continuation-in-part of U.S. patent application Ser. No. 10/970,163, filed Oct. 21, 2004 by Banks et al., which is herein incorporated by reference in its entirety.

### BACKGROUND

The present invention relates generally to electronic business management, and relates more particularly to the managing, processing and modifying of and the provision of security to electronic business documents. Specifically, the present invention provides a method and apparatus for efficient electronic document management on demand and in a secure environment.

A single electronic business document, such as an electronic contract, can encompass a large number of collateral documents including master and/or customer agreements, supplements, addenda and the like. These various documents may exist in different file formats, have different document formatting, or may have different security settings (e.g., passwords to open and/or modify). A large number of complex (and often tedious) manual steps therefore must typically be implemented in order to manage and process the merging of individual documents into a single electronic document. As a result, the merging process is inefficient and frequently subject to human error.

For example, in a typical case, a user must first convert all of the individual documents into a uniform file format. In addition, each document must be checked for security settings, and any security settings limiting the user's ability to modify a document must be removed. Documents may then be modified one-by-one, for example to remove duplicate language or signature blocks. Once the documents have been appropriately modified, they must be manually merged, again one-by-one. The merged document may then require additional modification, such as formatting or renumbering. Finally, the user may want to add a security setting into the merged document before sending the document on to a customer for review, approval or execution. A plurality of similar steps must be implemented in order to add signature information into the document, for example after execution of an electronic contract by all parties.

In some cases, an electronic business document may require some kinds of managing and processing tasks to be performed in a secured environment. For example, a user may be required to merge two or more documents together into a single document. At the same time, the user may not be authorized to know passwords for accessing or modifying the documents, or may not be authorized to read the documents to be merged. In another example, an electronic business document may require approval signatures from two or more different parties, and this approval signature information should not be alterable by a subsequent user.

Thus, there is a need in the art for a method and apparatus for efficient electronic document management.

### SUMMARY OF THE INVENTION

In one embodiment, the present invention is a method and apparatus for efficient electronic document management. One embodiment of the inventive method involves retrieving a user-specific administrator setup file comprising a plurality of parameters pertaining to tasks that a user is authorized to perform on electronic documents, selecting at least one authorized task for performance on a selected electronic document, in accordance with the user-specific administrator setup files, and executing the selected authorized tasks in accordance with at least one set of predefined task execution instructions.

### BRIEF DESCRIPTION OF THE DRAWINGS

So that the manner in which the above recited embodiments of the invention are attained and can be understood in detail, a more particular description of the invention, briefly summarized above, may be obtained by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram illustrating a document management system, according to one embodiment of the present invention;

FIG. 2 is a flow diagram illustrating a one embodiment of a method for processing electronic documents, for example for implementation by the document management system illustrated in FIG. 1;

FIG. 3 is a flow diagram illustrating one embodiment of a method for generating user configuration files, for example for implementation by a user of the document management system illustrated in FIG. 1;

FIG. 4 is a flow diagram illustrating one embodiment of a method for executing selected tasks, for example for implementation by one of the task execution modules illustrated in FIG. 1; and

FIG. 5 is a high level block diagram of the present invention implemented using a general purpose computing device.

To facilitate understanding, identical reference numerals have been used, where possible, to designate identical elements that are common to the figures.

### DETAILED DESCRIPTION

In one embodiment, the present invention is a method and apparatus for efficient electronic document management. The method and apparatus of the present invention provide an efficient, automated system for the processing, managing and merging of electronic documents in a secure environment. The system substantially eliminates the potential for human error and security breaches in the performance of document management tasks.

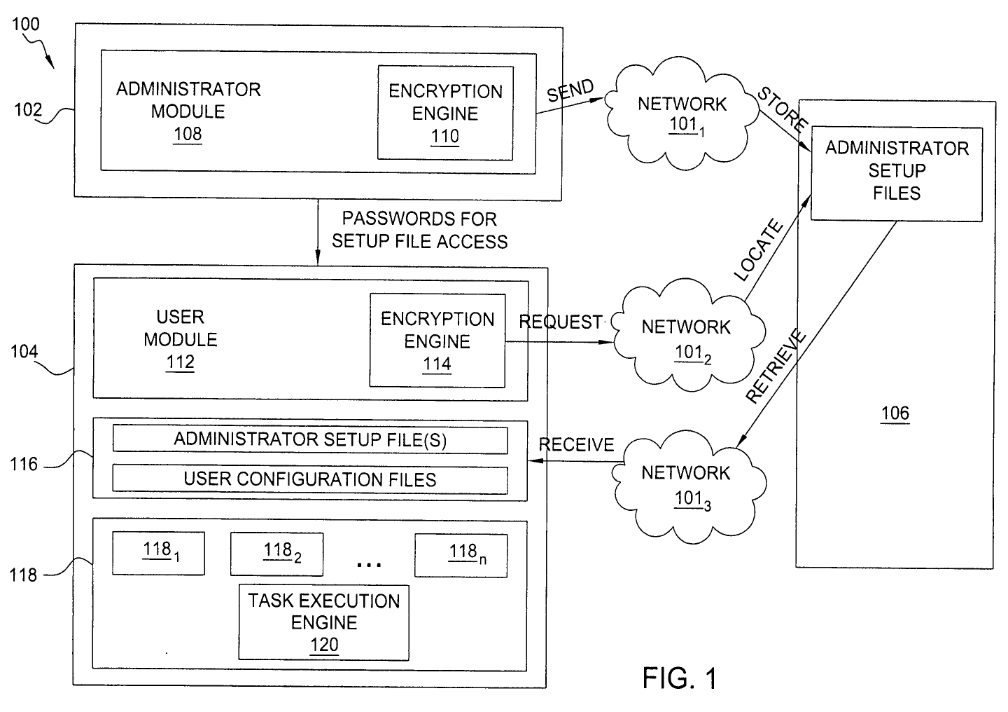

FIG. 1 is a schematic diagram illustrating a document management system 100, according to one embodiment of the present invention. The document management system 100 comprises an administrator 102 and at least one. user 104 linked to a common database 106 by one or more networks 1011-3 (hereinafter collectively referred to as “networks 101”). In one embodiment, the networks 101 are secure wired or wireless networks.

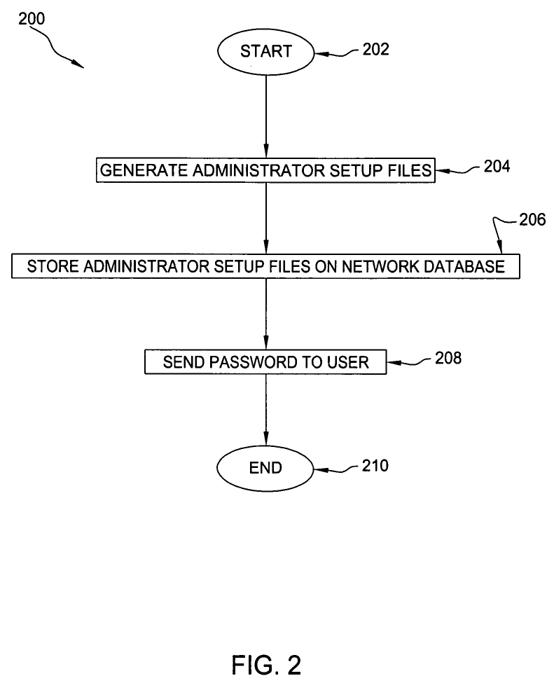

As described in further detail below in conjunction with FIG. 2, the administrator 102 is adapted to generate user-specific setup files that allow a particular user or group of users, e.g., user 104, to perform tasks in accordance with the user's or group of users' predefined role and security level in the system 100. As used herein, the term “task” may also include one or more allowable steps that a user or group of users must execute in order to complete the task. In one embodiment, the system 100 comprises a plurality of users, each assigned to perform a different task or set of tasks. In further embodiments, the plurality of users may be grouped into two or more different groups of users having similar (e.g., substantially the same) roles and security levels, where each group of users is assigned to perform a different task or set of tasks. For example, in one embodiment, both the roles and the security levels for a plurality of users in a common group are the same.

The administrator 102 comprises an administrator module 108 that includes an administrator encryption engine 110. The administrator module 108 is adapted to generate a plurality of administrator setup files and send these setup files to the database 106, where the setup files are stored for retrieval by the appropriate users. The encryption engine 110 is adapted to encode one or more parameters of the administrator setup files before the administrator setup files are sent to the database 106. In one embodiment, the encryption engine 110 includes a built-in private key for encoding the administrator setup files.

The user 104 comprises a user module 112, a local database 116 and a plurality of task execution modules 118₁-118ₙ (hereinafter collectively referred to as “task execution modules 118”). The user module 112 includes a user encryption engine 114 that is adapted for decoding the user's administrator setup files. In one embodiment, the user encryption engine 114 includes the same built-in private key that is incorporated into the administrator encryption engine 110 (but in the user's case, the built-in private key is used for decoding rather than encoding), so that no other user (or entity outside of the system 100) can reveal or use the private key to decode the user's administrator setup files except for the designated user 104. The private key and encoding/decoding methods are built into the encryption engines to ensure that the private key and encoding/decoding methods cannot be revealed to or used by an unauthorized party, e.g., to gain unauthorized access to administrator setup files. In one embodiment, even the user cannot reveal the private key and encoding/decoding methods; only software codes running on the administrator module 108 and the user module 112 can reveal and utilize the private key and encoding/decoding methods.

As described in further detail below, the local database 116 is adapted to store the retrieved administrator setup files, as well as user-generated user configuration files that detail the allowable tasks and steps that the user 104 has been designated to perform and information pertaining to the user 104's security access levels. In alternative embodiments, the local database 116 may be a remote or network database.

The task execution modules 118 are adapted to carry out the tasks and steps detailed in the user configuration files. In one embodiment, each task execution module further comprises a set of predefined task execution instructions for a particular task and its associated steps. A separate task execution engine 120 is adapted for carrying out the different task execution instructions in accordance with the predefined tasks and various configuration files, as described in greater detail below.

FIG. 2 is a flow diagram illustrating one embodiment of a method 200 for processing electronic documents, for example for implementation by the system 100. The method 200 is initialized at step 202 and proceeds to step 204, where the method generates at least one administrator setup file for a system user or group of system users, e.g., user 104. As described above, each administrator setup file is user-specific and is configured according to a particular user's (or group of users') role, level and position in the system 100.

An administrator setup file comprises a plurality of parameters, some of which are encoded using the encryption engine 110 as described above. For example, in one embodiment, the administrator setup file contains all the information concerning a user's or group of users' predefined allowable tasks (and their steps) and security access levels, which the user or group of users can implement in managing the system's electronic documents according to its role in the system 100. For example, a particular administrator setup file may allow a user or group of users to merge a plurality of documents, to add digital signatures to a document, and/or to modify certain document contents. Alternatively, the administrator setup file may forbid certain tasks to be executed by a particular user or group of users (e.g., modification of certain documents).

In one embodiment, the administrator setup file also contains security settings for each task and step, and passwords for accessing different types of documents with different security settings and/or privileges. In one embodiment, these passwords may be required for one or more different purposes, including, but not limited to, reading, modifying, merging, cutting and pasting to or from, adding watermarks to, adding background colors to and adding stamps to an electronic document. In one embodiment, parameters of the nature described above are encoded by the encryption engine 110 such that the parameters can only be decoded by the corresponding encryption engine 114 in the user module 112, which includes the same built-in private key. This ensures that the intended user or group of users cannot reveal, view or decode the parameters manually. In further embodiments, any security technique that functions in a manner similar to the built-in private key may be used to securely encode and decode parameters of the administrator setup files.

In one embodiment, rules governing the security settings are generated by company policies, which are provided to the administrator module 108 and used by the administrator module 108 in generating the administrator setup files in step 204. In one embodiment, the administrator module 108 selects different company policies for incorporation based on the nature of the electronic documents to be managed, the nature of the management tasks to be performed, or the roles, security levels and/or company positions of the user(s) selected to perform the tasks. In another embodiment, these company policies also specify (e.g., generate or dictate) documents for management and processing, as well as tasks to be performed in accordance with the management and processing of the documents.

In further embodiments, the administrator module 108 may implement these company policies in order to build a set of document management and processing rules, as well as a set of security rules. In accordance with the set of security rules, a plurality of passwords with different privileges may be set for accessing each selected electronic document type. For example, in one embodiment, each document type can have more than one password (e.g., a first password for reading the document type, a second password for modifying the document type, a third password for adding a watermark to the document type, etc.), where documents of the same type have the same set of passwords. Moreover, as discussed above, the administrator module 108 may implement the company policies to determine the allowable tasks (including the associated steps) and security settings for each document type required by each task, with respect to the sets of management, process and security rules generated.

In one embodiment, other parameters including names and types of documents, or names of tasks and their associated steps, are not encoded. The administrator module 108 provides the graphical user interfaces (GUIs) and scripts to enable the administrator 102 to construct the administrator setup files. Thus, different users (and different groups of users) of different roles, levels and positions can perform different management or processing tasks and steps on different types of documents.

Once the administrator setup files have been generated and the parameters encoded using the administrator encryption engine 110, the method 200 proceeds to step 206 and sends the administrator setup files to the system database 106 for storage. The method 200 then sends an administrator-generated password to the user 104 (or group of users) in step 208. The password allows the user 104 (or group of users) to access its respective administrator setup files from the database 106 and view any unencoded parameters in the retrieved administrator setup files. The method 200 then terminates in step 210.

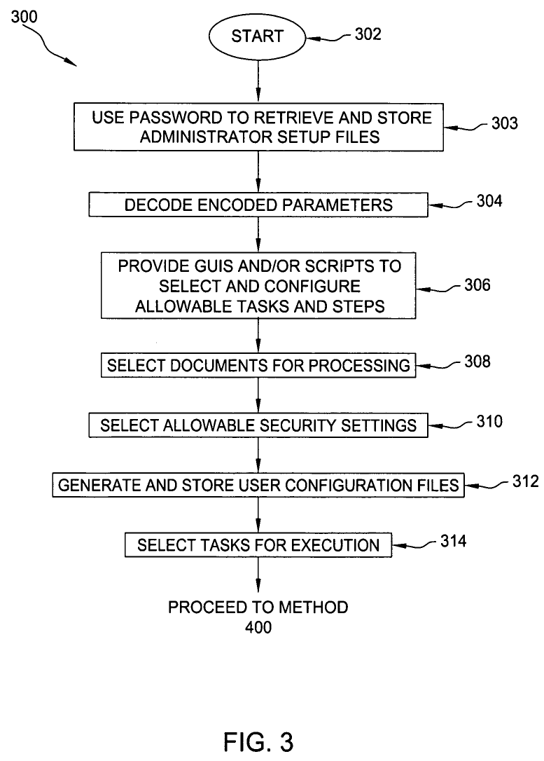

FIG. 3 is a flow diagram illustrating one embodiment of a method 300 for generating user configuration files, for example for implementation by a user of a document management system (e.g., user 104 of system 100). The method 300 is initialized at step 302 and proceeds to step 303, where the method 300 uses a password (received, for example, from the administrator 102) to access the user's respective administrator setup files from the system database 106. The method 300 then stores the retrieved administrator setup files on a second database associated with the user (e.g., the user's local database 116) and implements the retrieved administrator setup files to allow performance of one or more document management and processing tasks, as describe in further detail below.

In step 304, the method 300 decodes the encoded parameters in the retrieved administrator setup files. Specifically, the method 300 decodes the parameters for the user's allowable tasks (and the associated steps), as well as any allowable security settings for the electronic documents to be processed (however, in one embodiment, document passwords are not yet decoded at this step). As described above, decoding of parameters at a user is performed using a private key built into the user module. The private key built into the user module matches a private key built into the administrator module and used to encode the parameters.

The method 300 then proceeds to step 306 and provides the user with the necessary graphical user interfaces (GUIs) and/or scripts to enable the user to select and configure allowable tasks and steps. In one embodiment, the GUIs and scripts are generated by the respective user modules 112. Once the appropriate tasks and steps have been selected, the method 300 proceeds to step 308 and selects electronic documents for processing by the selected tasks and steps. The electronic documents are selected in accordance with the user's predefined role in the system 100. The method 300 then proceeds to step 310 and selects the allowable security settings for each document under each task.

Once the method 300 has selected the allowable tasks, documents and security settings, the method 300 proceeds to step 312 and generates a plurality of user configuration files. The user configuration files contain all of the information necessary to allow a task execution module 118 to process the selected electronic documents. For example, a user configuration file may specify a particular group of documents that the user wishes to merge, or the particular modifications a user wishes to make to a document or group of documents, and the steps for carrying out these tasks. The method 300 stores these user configuration files on the second database, e.g., a user's local database 116.

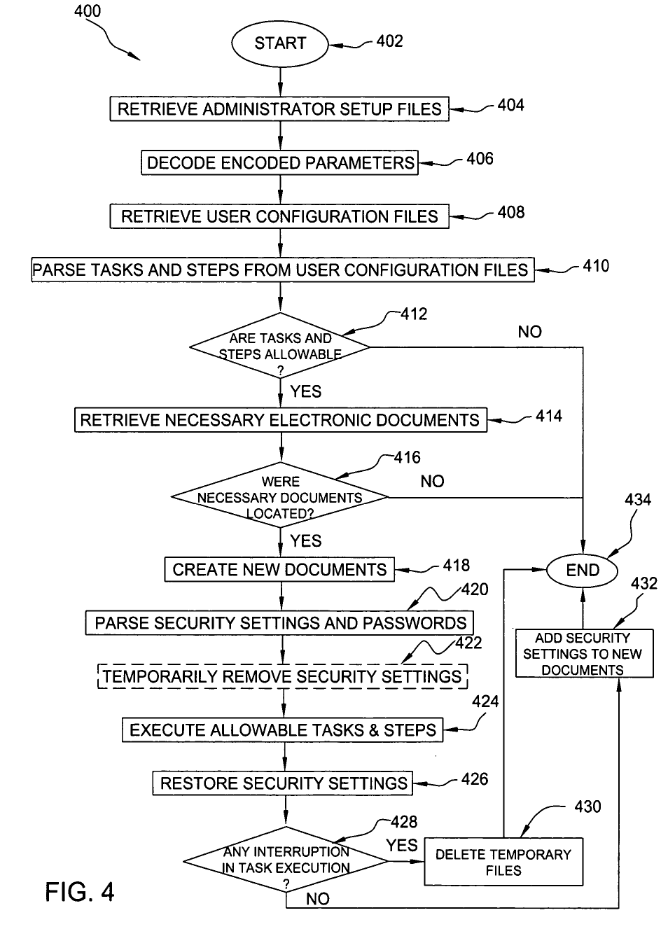

Finally, in step 314, the method 300 selects the tasks that the user 104 wishes to execute on the selected documents. Task selection may be made one-by-one, all at once, or in a specified order. Moreover, task selection may be made with the help of system graphical user interfaces or scripts. Once the tasks are selected, the tasks are executed by the corresponding task execution module 118 as described below in conjunction with FIG. 4.

FIG. 4 is a flow diagram illustrating one embodiment of a method 400 for executing selected tasks, for example for implementation by a task execution module 118. The method 400 is initialized at step 402 and proceeds to step 404, where the method 400 retrieves one or more administrator setup files from the second database (e.g., a user's local database). In step 406, the method 400 decodes encoded parameters in the retrieved administrator setup file to determine the user's allowable tasks and steps. In one embodiment, the method 400 decodes these encoded parameters implicitly using the user encryption engine (e.g., user encryption engine 114 of FIG. 1). Within the context of the present invention, “implicit” decoding of the encoded parameters means that the method 400 “calls” the encryption engine directly rather than allowing the user or administrator to call the encryption engine on its behalf. In another embodiment, the method 400 decodes these encoded parameters implicitly using a dedicated encryption engine (e.g., associated with the task execution engine).

Once the parameters have been properly decoded, the method 400 proceeds to step 408 and retrieves the user configuration files (e.g., the files generated by the method 300) from the second database. In step 410, the method 400 parses the user configuration files for selected tasks and steps.

In step 412, the method 400 inquires if the selected tasks and steps are allowable, e.g., in accordance with the user's role in the system 100. If the method 400 determines that the tasks and steps are not allowable, the method 400 terminates at step 434. Alternatively, if the method 400 determines that the tasks and steps are allowable, the method 400 proceeds to step 414 and attempts to retrieve the selected electronic documents for processing. In step 416, the method 400 inquires if the selected documents were located. If the documents were not located, the method 400 terminates at step 434. Alternatively, if the necessary documents were located, the method 400 proceeds to step 418 and creates a plurality of new documents based on the user configuration files.

In step 420, the method 400 decodes parameters of the administrator setup files to parse the security settings and passwords for each type of selected document. In one embodiment, the selected documents are protected by a plurality of different security settings and passwords having different privileges (e.g., as determined by the electronic document types). In this embodiment, the method 400 must parse the security settings and passwords for each type of electronic document selected. In one embodiment, the method 400 temporarily removes the security settings from at least some of the documents in step 422. This may be desirable, for example, in cases where the user's security access is so low that the user is not normally allowed to view one or more documents that he or she must process in accordance with an assigned task. In step 424, the method 400 executes the allowable tasks and steps, e.g., using task execution modules 118. In one embodiment, task execution may be carried out using any scripts or application programming interfaces (APIs) packaged together as functions or subroutines for all the predefined tasks and steps with input from the user configuration files. Moreover, task execution may be performed one-by-one, in a specific or random order, or simultaneously. Once the allowable tasks and steps have been executed, the method 400 restores the security settings as necessary for all documents in step 426. Thus, even a user with low security access is enabled to view all appropriate documents for the time necessary to carry out his or her assigned tasks.

In step 428, the method 400 inquires if any interruption has occurred during the execution of the tasks and steps. If the method 400 does not detect any interruptions, the method 400 proceeds to step 432 and adds appropriate security settings and passwords to all newly created documents. The method 400 then terminates at step 434. Alternatively, if the method 400 determines at step 428 that an interruption has occurred, all temporary files are deleted from the system 100 (e.g., no new documents are saved) at step 430, and the method 400 terminates at step 434. In this way, no faulty or unauthorized documents are retained by the system 100.

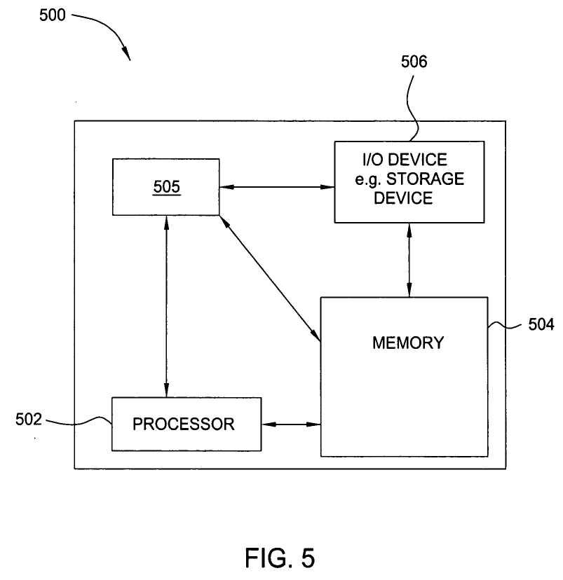

FIG. 5 is a high level block diagram of the present electronic document management system that is implemented using a general purpose computing device 500. In one embodiment, a general purpose computing device 500 comprises a processor 502, a memory 504, an electronic document manager or module 505 and various input/output (I/O) devices 506 such as a display, a keyboard, a mouse, a modem, and the like. In one embodiment, at least one I/O device is a storage device (e.g., a disk drive, an optical disk drive, a floppy disk drive). It should be understood that the electronic document manager 505 can be implemented as a physical device or subsystem that is coupled to a processor through a communication channel.

Alternatively, the electronic document manager 505 can be represented by one or more software applications (or even a combination of software and hardware, e.g., using Application Specific Integrated Circuits (ASIC)), where the software is loaded from a storage medium (e.g., I/O devices 506) and operated by the processor 502 in the memory 504 of the general purpose computing device 500. Thus, in one embodiment, the electronic document manager 505 for allocating resources among entities described herein with reference to the preceding Figures can be stored on a computer readable medium or carrier (e.g., RAM, magnetic or optical drive or diskette, and the like).

Thus, the present invention represents a significant advancement in the field of electronic document management. A method and apparatus are provided that enable a user to manage and process electronic documents in an automated, secure environment. The present invention allows only authorized users (e.g., authorized by an administrator pursuant to system policies) to access particular documents and to perform particular processing tasks, thereby preserving the integrity of the processed documents. Moreover, the present invention substantially eliminates the potential for human error in management processes by automating management tasks and their steps in a secure environment.

While foregoing is directed to the preferred embodiment of the present invention, other and further embodiments of the invention may be devised without departing from the basic scope thereof, and the scope thereof is determined by the claims that follow.

1. A method for accessing and managing electronic documents, the method comprising the steps of:
retrieving one or more user-specific administrator setup files comprising a plurality of parameters pertaining to at least one task that a user is authorized to perform on at least one electronic document;
selecting at least one authorized task for performance on a selected electronic document or on a group of electronic documents, in accordance with said one or more user-specific administrator setup files; and
executing said at least one selected authorized task in accordance with at least one set of predefined task execution instructions.

2. The method of claim 1, wherein at least one of said one or more user-specific administrator setup files is specific to a group of users having substantially the same roles in an associated electronic document management system.

3. The method of claim 2, wherein said group of users share substantially the same security level.

4. The method of claim 1, wherein at least one of said at least one task and said selected electronic document or group of electronic documents are specified by at least one company policy.

5. The method of claim 4, wherein said at least one company policy is further implemented to generate at least one of: management rules for said selected electronic document or group of electronic documents, processing rules for said selected electronic document or group of electronic documents and security rules for said selected electronic document or group of electronic documents.

6. The method of claim 5, wherein said security rules include different passwords for processing different types of electronic documents.

7. The method of claim 5, wherein said security rules are encoded using an encryption engine.

8. The method of claim 7, further comprising:
decoding said security rules in accordance with said encryption engine.

9. The method of claim 8, wherein said decoding is performed implicitly.

10. A computer readable medium containing an executable program for accessing and managing electronic documents, where the program performs the steps of:
retrieving one or more user-specific administrator setup files comprising a plurality of parameters pertaining to at least one task that a user is authorized to perform on at least one electronic document;
selecting at least one authorized task for performance on a selected electronic document or on a group of electronic documents, in accordance with said one or more user-specific administrator setup files; and
executing said at least one selected authorized task in accordance with at least one set of predefined task execution instructions.

11. The computer readable medium of claim 10, wherein at least one of said one or more user-specific administrator setup files is specific to a group of users having substantially the same roles in an associated electronic document management system.

12. The computer readable medium of claim 11, wherein said group of users share substantially the same security level.

13. The computer readable medium of claim 10, wherein at least one of said at least one task and said selected electronic document or group of electronic documents are specified by at least one company policy.

14. The computer readable medium of claim 13, wherein said at least one company policy is further implemented to generate at least one of: management rules for said selected electronic document or group of electronic documents, processing rules for said selected electronic document or group of electronic documents and security rules for said selected electronic document or group of electronic documents.

15. The computer readable medium of claim 14, wherein said security rules include different passwords for processing different types of electronic documents.

16. The computer readable medium of claim 14, wherein said security rules are encoded using an encryption engine.

17. The computer readable medium of claim 16, further comprising:
decoding said security rules in accordance with said encryption engine.

18. The computer readable medium of claim 17, wherein said decoding is performed implicitly.

19. An electronic document management system, comprising:
means for retrieving one or more user-specific administrator setup files comprising a plurality of parameters pertaining to at least one task that a user is authorized to perform on at least one electronic document;
means for selecting at least one authorized task for performance on a selected electronic document or on a group of electronic documents, in accordance with said one or more user-specific administrator setup files; and
means for executing said at least one selected authorized task in accordance with at least one set of predefined task execution instructions.

20. The system of claim 19, wherein at least one of said one or more user-specific administrator setup files is specific to a group of users having substantially the same roles in an associated electronic document management system.
